(19) United States
(12) Patent Application Publication
(10) Pub. No.: US 2007/0168269 A1
(43) Pub. Date: Jul. 19, 2007

(54) Method for analyzing financial stock market trend

(76) Inventor: Kuo-Yu Chuo, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/332,356

(22) Filed: Jan. 17, 2006

(51) Int. Cl. G06Q 40/00

(52) U.S. Cl. 705/36 R

(57) ABSTRACT

A method for analyzing a financial stock market trend according to this invention is provided, in which a parameter formula is used to form a long-term trend region and an intermediate-term trend region and to analyze a Bull-and-Bear trend in a long period of the financial stock market and in an intermediate period of the financial stock market; a short-term trend is further used to analyze and show a Bull-and-Bear trend in a short period of the financial stock market; finally, according to the long-term trend region, the intermediate-term trend region, and the short-term trend, the trend of financial stock market is forecast, and the uncomplicated, precise method for analyzing the structure of financial stock market trend is provided for a user to heighten his or her profit and lower his or her risk of investment.

### BACKGROUND OF THE INVENTION

1. Field of the Invention

This invention relates to a method for analyzing a financial stock market trend and particularly to that by means of different cycles given from various reference indices.

2. Description of Related Art

Generally, in a financial stock market, an investor makes reference to much information and uses various analytic tools to estimate the trend and risk of an invested target, before aiming at a target for investment. In the stock market, the investor estimates and analyzes four major situations, namely a basic situation, an information situation, a technique situation, and a counter situation so as to make an overall plan to analyze an initial value of the invested target.

In addition to the four major situations, many analytic and strategic systems are provided to assist the investor. However, either most of the strategic systems are either too complicated to determine or parameters to be analyzed cannot instantly be provided for reference, thereby a good opportunity of investment being missed.

For example, what explained in figures by some systems is not clear enough or a manner of informational sketch is too complicated to easily analyze, thereby causing the investor not easily operating. Further, the parameters are not precisely analyzed, the operation is not yet detailed and complete, and the whole structure is not enough exact and comprehensive, and thus the investor erroneously read and judgment is caused to let the investor is confronted with the higher risk of a loss.

### SUMMARY OF THE INVENTION

In consideration of poor effects derived from a conventional manner, a method for analyzing a financial stock market trend according to this invention is provided for an investor to read and determine the trend of financial stock market depending on a periodic parameter given after various index parameters are analyzed. An uncomplicated trend structure shown by the system is integrated with different periods for the user to read a coming trend; thus, beside easy read by the user, higher accuracy is achieved so as to promote the investor's profit and lower the investor's investment risk.

The method for analyzing the financial stock market trend according to this invention is provided, comprising steps of offering a trend channel to form a long-term trend region and an intermediate-term trend region, using the long-term trend region to analyze and show a Bull-and-Bear trend in a long period of the financial stock market, using the intermediate-term trend region to analyze and show a Bull-and-Bear trend in an intermediate period of the financial stock market, offering a short-term trend to analyze and show a Bull-and-Bear trend in a short period of the financial stock market, and finally following the long-term trend region, the intermediate-term trend region, and the short-term trend to forecast the trend of financial stock market.

In the method of analysis according to this invention, each trend may be analyzed in a figure of trend structure for a precise analysis on a coming trend. In other words, in this invention, a clear analysis interface is provided to analyze the trend of financial stock market, and various index parameters are used to determine the coming trend of financial stock market, thereby the accuracy of analysis being greatly increased.

In order to further know the features and technical means of this invention, refer to the detailed description according to this invention accompanied with drawings; however, the accompanied drawings are provided for reference and illustration only and are not limited to this invention.

### BRIEF DESCRIPTION OF THE DRAWINGS

FIG. 1 is a view of a trend structure of a preferred embodiment of this invention;

FIG. 2 is a schematic view illustrating each trend of the preferred embodiment of this invention;

FIG. 3 is an analytic view of the trend structure of a bull market of a bull-and-bull analysis on all listed stocks in the preferred embodiment of this invention;

FIG. 4 is an analytic view of the trend structure of a bear market of a bull-and-bull analysis on all listed stocks in the preferred embodiment of this invention;

FIG. 5 is an analytic view of the trend structure of a bull market of a stock bull-and-bull analysis in the preferred embodiment of this invention;

FIG. 6 is an analytic view of the trend structure of the bear market of the stock bull-and-bull analysis in the preferred embodiment of this invention;

FIG. 7 is an analytic view of the trend structure of the bull market of a future's index bull-and-bull analysis in the preferred embodiment of this invention; and

FIG. 8 is an analytic view of the trend structure of the bear market of the future's index bull-and-bull analysis in the preferred embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

A trend structure is calculated to mainly modify a manner of calculating a single period that was set before. An oscillation amplitude channel of a last period is used together with a smooth technique so that a smooth value may be given for reference at this period. Lines are generally found complicated when the data given from previous short-term periods, but an improvement is made by means of a smooth analysis. The channel is not the only one and various channels may be applied. As long as a formula of calculation is made along with the oscillation amplitude of stock price and the like, the value given from the previous period may be used; for example, at a day-line period, a channel applied to a cycle-line period is placed in the figure of the period, and similarly the value may be used only after an analysis of smooth technique.

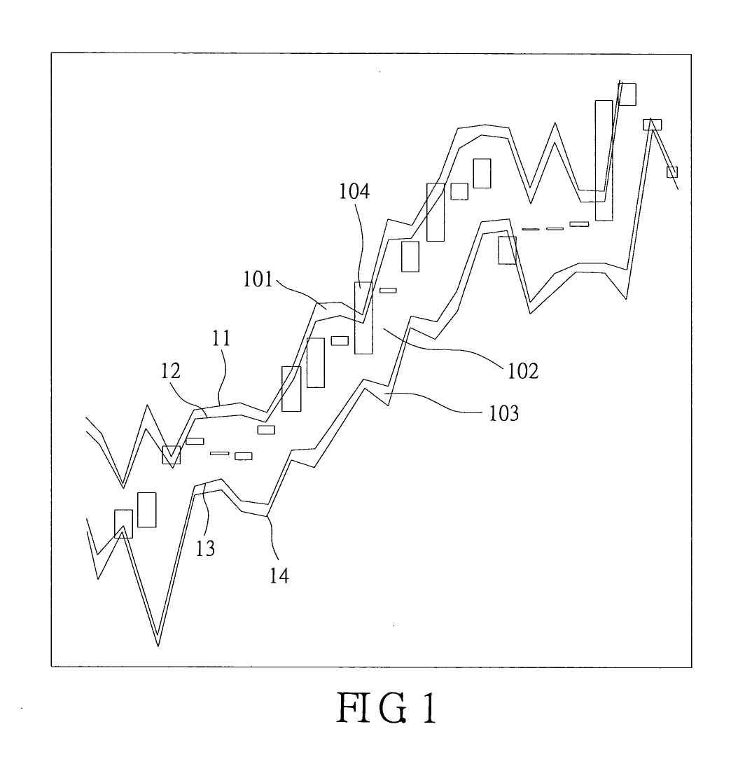

FIG. 1 is a view of a trend structure of a preferred embodiment of this invention. The analytic view of this invention is given for change of a former rule of trend judgment of a single cycle (or a single transaction mode). A bull-and-bear trend of this period is united with a bull-and-bear trend of last two periods as one, and further different principles of index may also be used for determination. For example, a former day's excess fare is used to get four trend parameters, namely 11, 12, 13, and 14, and formulae for calculation are given below:
A former day's ceiling price+(a former day's ceiling price−a former day's rock-bottom price)*0.618; Formula 1:
A former day's ceiling price+(a former day's ceiling price−a former day's rock-bottom price)*0.382; Formula 2:
A former day's rock-bottom price−(a former day's ceiling price−a former day's rock-bottom price)+(a former day's ceiling price−a former day's rock-bottom price)*0.618 Formula 3:
A former day's rock-bottom price−(a former day's ceiling price−a former day's rock-bottom price)+(a former day's ceiling price−a former day's rock-bottom price)*0.382 Formula 4:

From the four formulae given above, four trend parameters, 11, 12, 13, and 14, maybe obtained, and the four trend parameters, 11, 12, 13, and 14 are just enough formed into a trend channel, as shown in FIG. 1 for a trend structure of a preferred embodiment of this invention.

Also, due to the trend parameters, 11, 12, 13, and 14, the trend parameters are divided into three regions, a first long-term trend region 101, a second long-term trend region 103, and an intermediate-term trend region 102. The long-term trend region 101 uses a long-cycle index, a Moving Average Convergence/Divergence (MACD), a Stochastic Oscillator (KD), or a Relative Strength Index (RSI) to analyze a Bull-and-Bear trend in a long period of the financial stock market, while the intermediate-term trend region trend region uses an intermediate-cycle index, a Moving Average Convergence/Divergence (MACD), a Stochastic Oscillator (KD), or a Relative Strength Index (RSI) to analyze a Bull-and-Bear trend in an intermediate period of the financial stock market.

Next, a bull-and-bear judgment made by the analytic view of trend structure will be described below. In a day-line period, the Moving Average Convergence/Divergence (MACD), the Stochastic Oscillator (KD), or the Relative Strength Index (RSI) is used to determine a bull-and-bear situation. When a K value at a cycle line is larger than a D value at a cycle line, the intermediate-term trend region 102 is marked in red (as a bull trend); on the other hand, when a K value at a cycle line is smaller than a D value at a cycle line, the intermediate-term trend region 102 is marked in green (as a bear trend). When a K value at a month line is larger than a D value at a cycle line, the first long-term trend region 101 and the second long-term trend region 103 are marked in red (as a bull trend); on the other hand, when a K value at a cycle line is smaller than a D value at a cycle line, the first long-term trend region 101 and the second long-term trend region 103 are marked in green (as a bear trend); further, when a cycle K line 104 (a short-term trend) is marked in red and green, the bull-and bear trend of long term (the first long-term trend region 101 and the second long-term trend region 103), intermediate term (the intermediate-term trend region 102), and short term (the K line 104) may be definitely determined.

The bull-and bear situations of the first long-term trend region 101, the second long-term trend region 103, and the intermediate-term trend region 102 may be determined according to a same technique index or may be determined according to different technique indices of a period or different technique indices of different periods that are mutually alternated. Separately, the bear trends in the first long-term trend region 101, the second long-term trend region 103, and the intermediate-term trend region 102 are not necessarily marked in red and green but marked in another color to distinguish them.

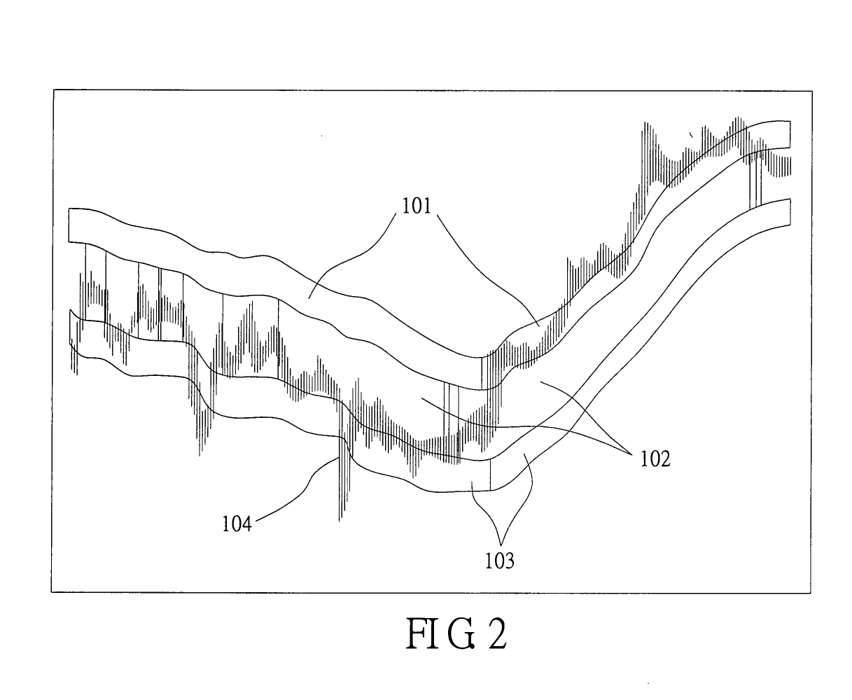

FIG. 2 is a view of each trend of a preferred embodiment of this invention. The figure concretely illustrates the trends in the first long-term trend region 101, the second long-term trend region 103, and the intermediate-term trend region 102. In the first long-term trend region 101 and the second long-term trend region 103, the long periods are used to analyze the bull-and-bear trend of stock market (or long-cycle indices or different periods of parameters, such as the Moving Average Convergence/Divergence (MACD), the Stochastic Oscillator (KD), or the Relative Strength Index (RSI)), and thus determine that the red region indicates the trend that turns upward and the green region indicates the trend that turns downward. In the intermediate-term trend region 102, the intermediate periods is used to analyze the bull-and-bear trend of stock market (or intermediate-cycle index or different periods of parameters, such as the Moving Average Convergence/Divergence (MACD), the Stochastic Oscillator (KD), or the Relative Strength Index (RSI)), and thus determine that the red region indicates the trend that turns upward and the green region indicates the trend that turns downward. In the short-term trend region 104, the short period is used to analyze the bull-and-bear trend of stock market (or short-cycle index or different periods of parameters, such as the Moving Average Convergence/Divergence (MACD), the Stochastic Oscillator (KD), or the Relative Strength Index (RSI)), and thus determine that the red region indicates the trend that turns upward and the green region indicates the trend that turns downward. The three trends that turn upward indicate that the corresponding trend of stock market rapidly soars; contrarily, the three trends that turn downward indicate that the corresponding trend of stock market rapidly alights.

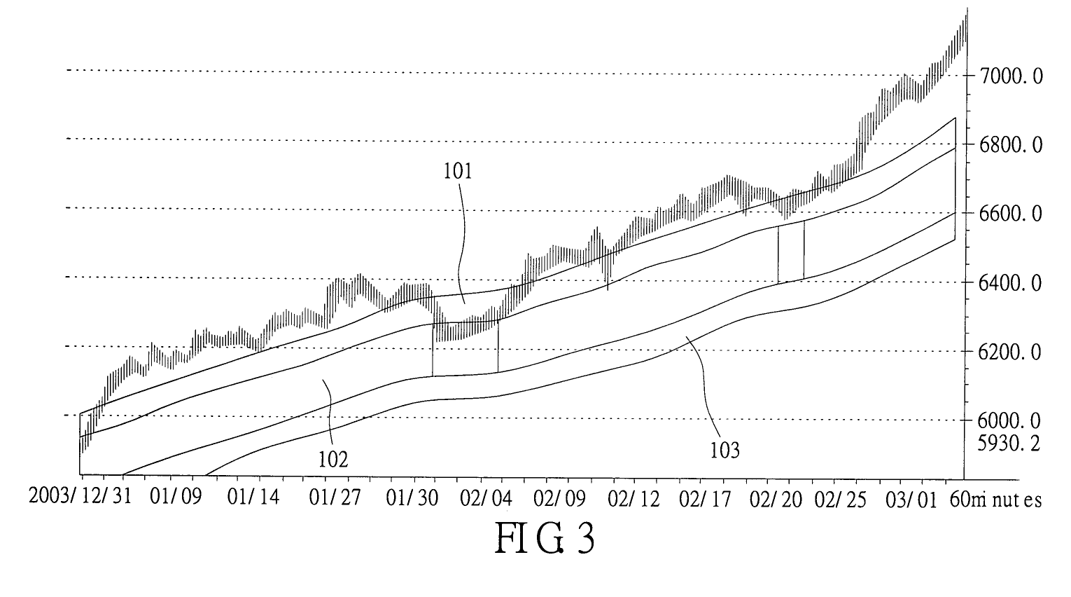

FIG. 3 is an analytic view of the trend structure of a bull market of a bull-and-bull analysis on all listed stocks in the preferred embodiment of this invention, in which the data was given from Dec. 31, 2003 to Mar. 5, 2004. Firstly, the first long-term trend region 101 is defined as a bull attack region, the second long-term trend region 103 is defined as a bear attack region, and the intermediate-term trend region 102 is defined as a bull-and-bull conflict region. However, as shown in FIG. 3, the trend of all listed stocks is that of bull attack. On Dec. 31, 2003, after a tail quotation was closed, three lines turned many signals (long-term, intermediate-term, short-term trends that went upward) and immediately stood at the bull attack region 101 on Jan. 2, 2004. Pullback on Feb. 2, 2004 and Feb. 2, 2004 is formed at half bull-and-bull conflict region, and when the digit all the way goes upward to 7135, a reversal signal appears; all the listed stocks all the way goes from point 5877 upward to point 7054 and no yield signal appears.

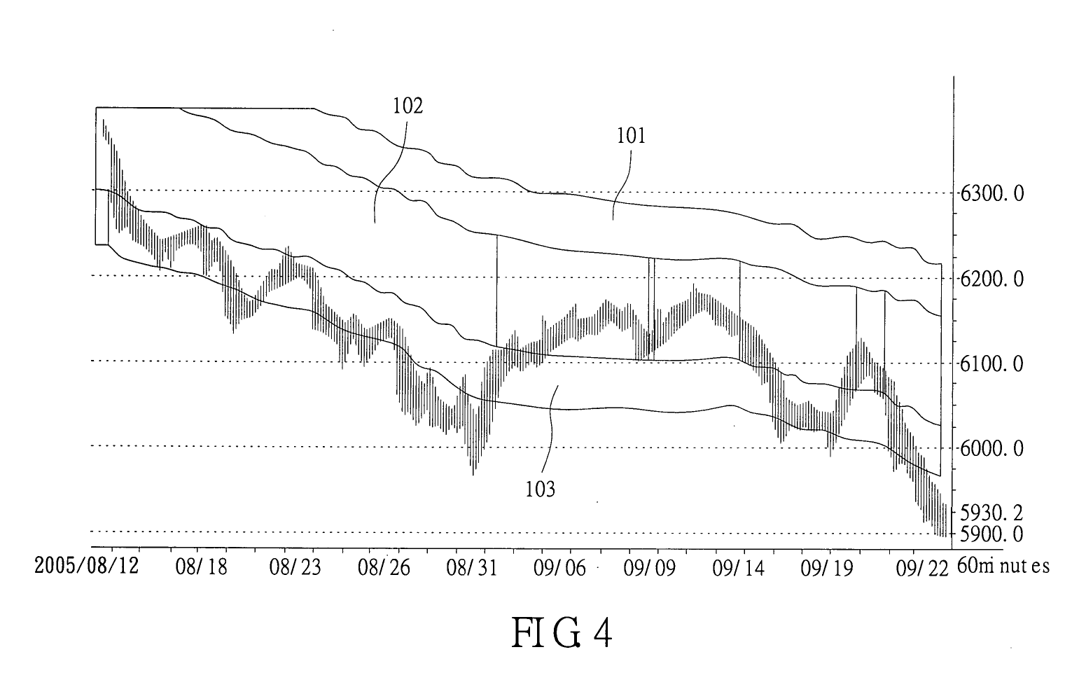

FIG. 4 is an analytic view of the trend structure of a bear market of a bull-and-bull analysis on all listed stocks in the preferred embodiment of this invention. In the figure, it is apparent that a weighted index number on a 60-minute line at 13:30 on Aug. 12, 2005 went downward, and from the day up to the closing-quotation time of Sep. 23, 2005, the number all the way went up and down at the bear attack region 103 and the bull-and-bull conflict region 102 and the bear attack signal appeared unceasingly; further, due to rebound in many ways the situation cannot stand at the bull attack region 101, and no information in many ways was released during this period, so selling all stocks or borrow stocks was the major.

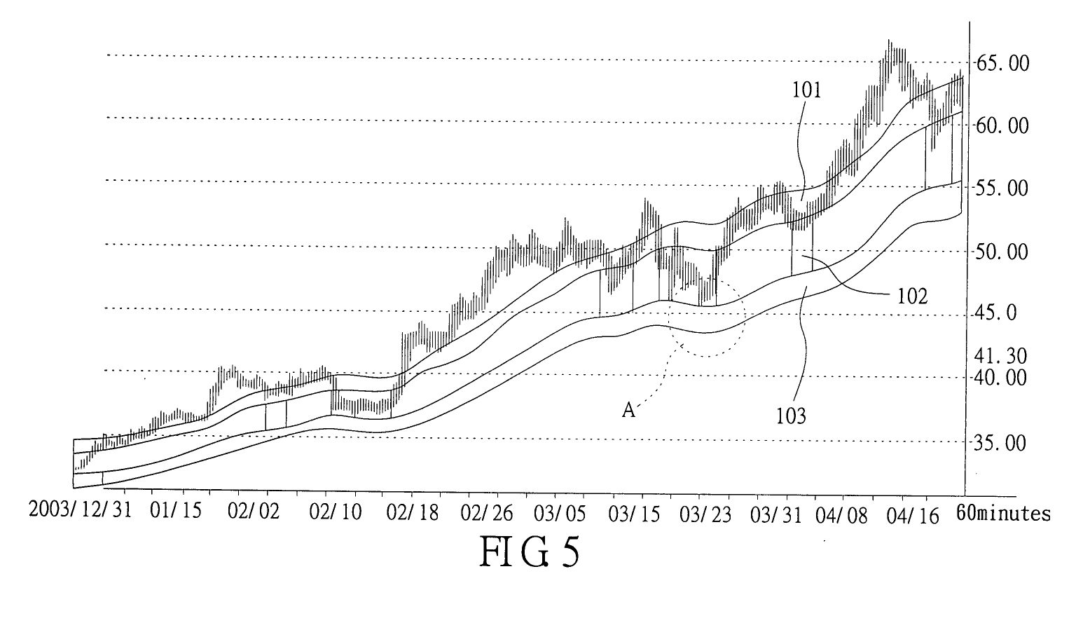

FIG. 5 is an analytic view of the trend structure of a bull market of a bull-and-bull analysis on stocks in the preferred embodiment of this invention. The figure illustrates the trend of AUO in stock market from Jan. 6, 2004 to Apr. 16, 2004, in which the bull attack trend existed from Jan. 6, 2004 and during the attack signal in many ways, although the backpressure of stock price having fallen down due to politics occurred so that a signal of false drop was formed, the pullback did not break the bear attack region 103, as shown in a portion A of FIG. 5), and the attack vigor did not change.

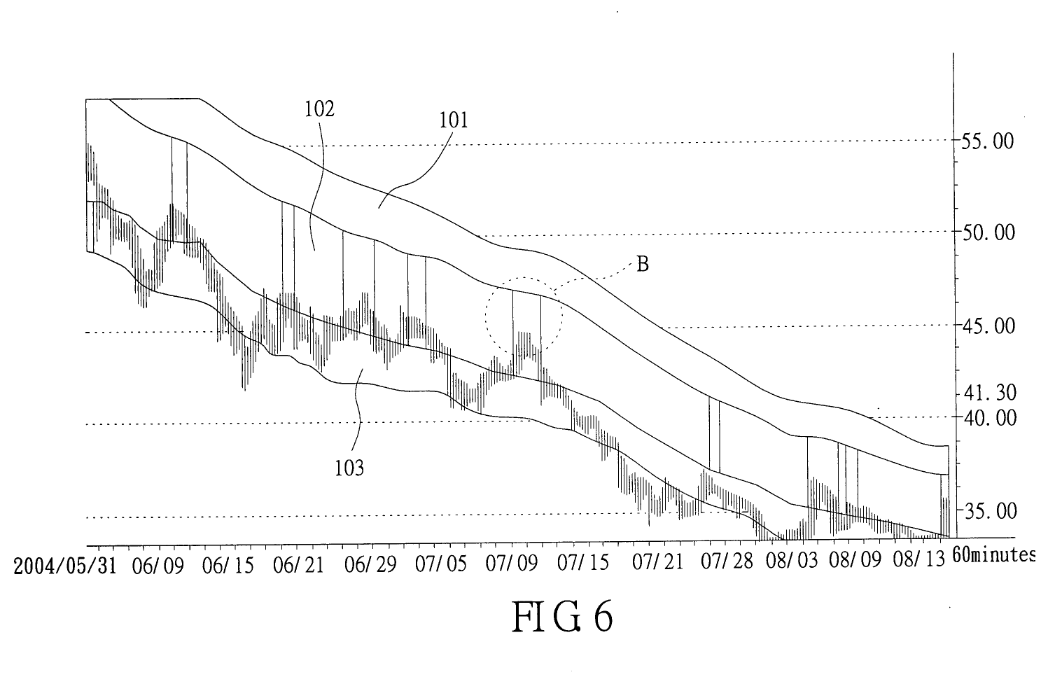

FIG. 6 is an analytic view of the trend structure of a bear market of a bull-and-bull analysis on stocks in the preferred embodiment of this invention. The figure illustrates, for example, the trend of AUO in stock market from May 31, 2004 to Aug. 13, 2004 and the bear attack trend starting from May 31, 2004, in which due to rebound, the situation cannot stand at the bull attack region 101, as shown in a portion B of FIG. 6, and the stock price at all times slide down to a toll gate of 36.

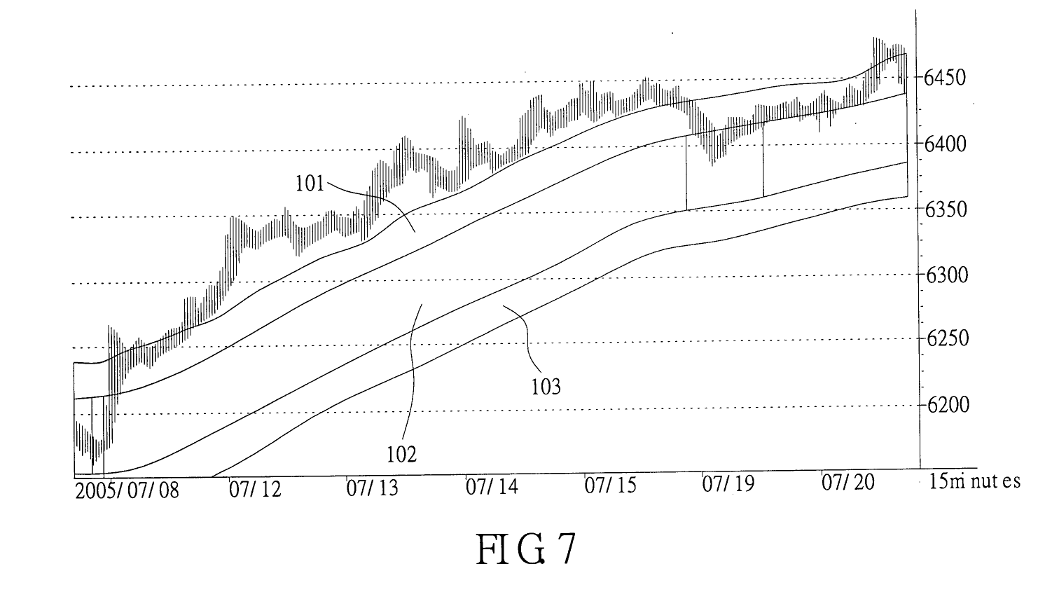

FIG. 7 is an analytic view of the bull market of bull-and-bull analysis on the future's index in the preferred embodiment of this invention. FIG. 7 illustrates a 15-minute-based operation cycle and a bull trend from Jul. 8, 2005 to Jul. 20, 2005. In this period, although being pulled back, the stock price always stays on the bull-and-bull conflict region 102, an upward trend.

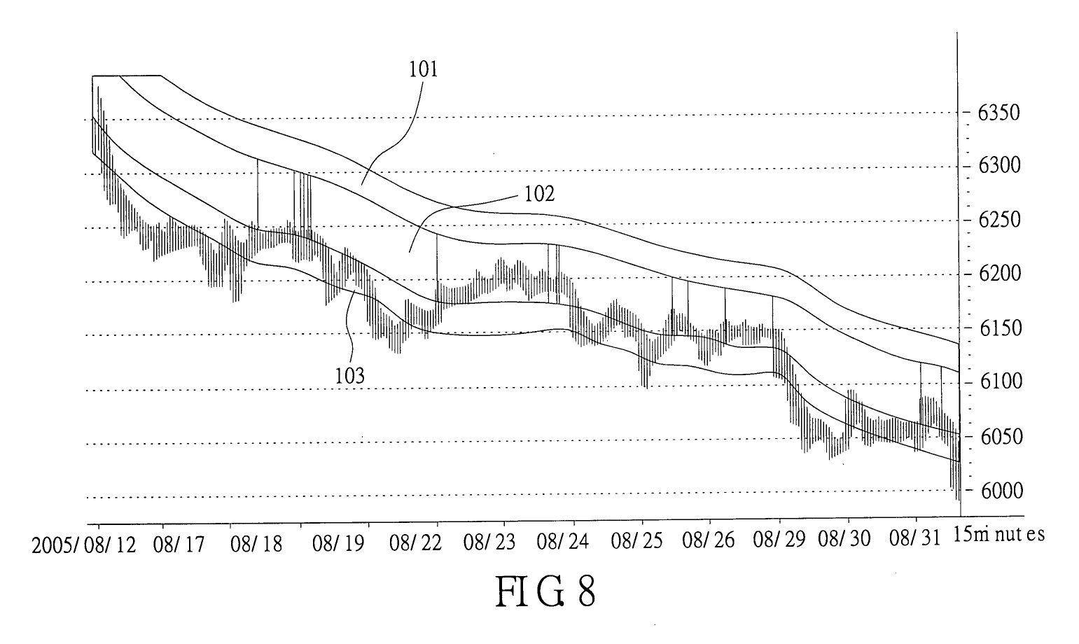

FIG. 8 is an analytic view of the bear market of bull-and-bull analysis on the future's index in the preferred embodiment of this invention. FIG. 8 illustrates a trend of Taiwan futures from Aug. 12, 2005 to Aug. 31, 2005. At that time, the bear attack trend was formed so as to make the trend of stock price went unceasingly to and fro at the bear attack region 103 and the bull-and-bull conflict region 102 and further make the trend moved downward unceasingly.

To sum up, from the analytic view of trend structure according to this invention, the trend of each financial stock market may be analyzed so that a future trend thereof may be easily and precisely analyzed, and a clear analysis interface is provided. The three different cycles (long term, intermediate term, and short term) formed of various index parameters are used to determine the coming trend of financial stock market, thereby the accuracy of analysis being greatly increased, the investor's profit being lifted, and the risk of investment being decreased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for analyzing a financial stock market trend, comprising steps of:
offering a trend channel to form a long-term trend region and an intermediate-term trend region;
using the long-term trend region to analyze and show a Bull-and-Bear trend in a long period of the financial stock market;
using the intermediate-term trend region to analyze and show a Bull-and-Bear trend in a intermediate period of the financial stock market;
offering a short-term trend to analyze and show a Bull-and-Bear trend in a short period of the financial stock market; and
following the long-term trend region, the intermediate-term trend region, and the short-term trend to forecast the trend of financial stock market.

2. The method for analyzing a financial stock market trend according to claim 1, wherein the trend channel obtains a plurality of trend parameters by a parameter formula so that the long-term trend region and the intermediate-term trend region are formed.

3. The method for analyzing a financial stock market trend according to claim 2, wherein the parameter formula gets the trend parameters by a periodic bull-and-bear trend.

4. The method for analyzing a financial stock market trend according to claim 2, wherein the parameter formula gets the trend parameters by different principles of index.

5. The method for analyzing a financial stock market trend according to claim 1, wherein the trend of financial stock market is that of all-stock index.

6. The method for analyzing a financial stock market trend according to claim 1, wherein the trend of financial stock market is that of a single stock.

7. The method for analyzing a financial stock market trend according to claim 1, wherein the trend of financial stock market is that of a future's index.

8. The method for analyzing a financial stock market trend according to claim 1, wherein the long-term trend region, the intermediate-term trend region, and the short-term trend are used to analyze the trend of financial stock market that is bull, bear, or stock rearrangement.

9. The method for analyzing a financial stock market trend according to claim 1, wherein the long-term trend region comprises a first long-term trend region that lies at the top and bottom of trend channel, and a second long-term trend region.

10. The method for analyzing a financial stock market trend according to claim 1, wherein the long-term trend region 101 uses a long-cycle index, a Moving Average Convergence/Divergence (MACD), a Stochastic Oscillator (KD), or a Relative Strength Index (RSI) to analyze a Bull-and-Bear trend in a long period of the financial stock market.

11. The method for analyzing a financial stock market trend according to claim 1, wherein the intermediate-term trend region trend region uses an intermediate-cycle index, a Moving Average Convergence/Divergence (MACD), a Stochastic Oscillator (KD), or a Relative Strength Index (RSI) to analyze a Bull-and-Bear trend in an intermediate period of the financial stock market.

12. The method for analyzing a financial stock market trend according to claim 1, wherein the long-term trend region trend region and the intermediate-term trend region trend region uses a Moving Average Convergence/Divergence (MACD) of different cycles, a Stochastic Oscillator (KD), or a Relative Strength Index (RSI) to analyze a Bull-and-Bear trend in a long period of the financial stock market and in an intermediate period of the financial stock market.

13. The method for analyzing a financial stock market trend according to claim 1, wherein the long-term trend region is indicated in a color.

14. The method for analyzing a financial stock market trend according to claim 1, wherein if a long-cycle Bull-and-Bear trend of the financial stock market goes upward, the long-term trend region is indicated in red.

15. The method for analyzing a financial stock market trend according to claim 1, wherein if a long-period Bull-and-Bear trend of the financial stock market goes downward, the long-term trend region is indicated in green.

16. The method for analyzing a financial stock market trend according to claim 1, wherein the intermediate-term trend region is indicated in a color.

17. The method for analyzing a financial stock market trend according to claim 1, wherein if an intermediate-cycle Bull-and-Bear trend of the financial stock market goes upward, the intermediate-term trend region is indicated in red.

18. The method for analyzing a financial stock market trend according to claim 1, wherein if an intermediate-period Bull-and-Bear trend of the financial stock market goes downward, the intermediate-term trend region is indicated in green.

19. The method for analyzing a financial stock market trend according to claim 1, wherein when the long-term trend region, the intermediate-term trend region, and the short-term trend are shown going upward, it is indicated that the corresponding trend of stock market rapidly soars.

20. The method for analyzing a financial stock market trend according to claim 1, wherein when the long-term trend region, the intermediate-term trend region, and the short-term trend are shown going downward, it is indicated that the corresponding trend of stock market rapidly alights.
